(19) United States
(12) Patent Application Publication
(10) Pub. No.: US 2001/0047334 A1
(43) Pub. Date: Nov. 29, 2001

(54) System and method for using existing prepaid card systems for making payments over the internet

(76) Inventors: Victor Nappe, Keyport, NJ (US); Stephen Quirk, Millburn, NJ (US)

Correspondence Address: Anthony R. Barkume, Greenberg Traurig, LLP, 200 Park Avenue, New York, NY, 10166, US

(21) Appl. No.: 09/865,039

(22) Filed: May 24, 2001

Related U.S. Application Data
(60) Provisional application No. 60/206,758, filed on May 24, 2000.

(51) Int. Cl. G06F 17/60

(52) U.S. Cl. 705/41

(57) ABSTRACT

A system and method for executing payment for a transaction of goods or services between a merchant and a consumer over a network by using a prepaid consumer account, such as a telephone calling card account, to pay for the transaction. The consumer provides an account identifier to the merchant, which then sends a first transaction request message to a digital petty cash server (DPCS). The DPCS determines which one of several available account servers holds the consumer account identified by the consumer, and then sends a second transaction authorization request message to that account server. The account server determines if the consumer account is sufficient to cover the transaction amount; and then either deducts the transaction amount from the consumer account and completes the transaction, or it denies the transaction if the consumer account is insufficient to cover the DPCS transaction amount.

### CROSS REFERENCE TO RELATED APPLICATION

This application claims priority from copending U.S. patent application Ser. No. 60/206,758, filed May 24, 2000, the contents of which are incorporated by reference herein.

### BACKGROUND OF THE INVENTION

This invention relates to a system and method that utilizes the infrastructure and payment mechanisms of existing prepaid card systems, such as prepaid calling cards, for making payments for goods and services over the Internet.

A big challenge currently faced in the area of payment for goods and services over the Internet is the psychological and technological barrier of consumers using cash for Internet purchases. Existing payment systems allow for supposedly secure credit card payment mechanisms, but many consumer will not adopt their use since they do not believe that the mechanism is secure, and they are afraid that their credit card number will be made freely available to anyone over the Internet. Debit card system suffer from the same problems in adoption, since the consumer must enter his or her PIN to effect the use of the debit card, which is also perceived as not being secure for the same reason as credit cards.

Although some consumers are not concerned with Internet data security, they nonetheless do not want to use a credit card since they do not want their purchase linked to them; i.e. they want to remain anonymous. The use of cash allows a purchaser to remain anonymous when making a purchase at a store, but no mechanism exists that allows such purchase anonymity over the Internet.

It has also been found that most consumers are hesitant to adopt new systems that are different from the paradigms that they have been accustomed to. That is, intricate systems such as digital wallets and the like that have been proposed have not yet been widely adopted by consumers simply because consumers do not understand how they operate and are afraid that they may lose money by using them.

Finally, some existing payment systems do not allow for small purchase amounts; i.e. so-called “micropayments”, since the processing overhead is too expensive. Since many items of downloadable data (i.e. such as an article from an online service) could be charged for with small payments, a system that will allow such micropayments is desired.

Thus, it is desired to utilize a system for allowing consumers to make payments over the Internet that overcome these disadvantages of the prior art.

In particular, it is desired to provide such a payment system that is anonymous, easy to use, inexpensive to implement by building on an existing infrastructure, widely disseminated, and trusted by consumers.

### SUMMARY OF THE INVENTION

The present invention utilizes the unique ability to use existing prepaid cards such as telephone calling cards, subway passes, etc. to make payments for goods and services over the Internet. As described herein, a Digital Petty Cash Server (DPCS) has been designed to create a ubiquitous bridge between traditional billing systems (such as prepaid calling cards) and Internet online merchants. Essentially, by extending prepaid phone cards, the present invention leverages an existing distribution channel and consumer behavior. The DPCS system described herein is a payment technology that will allow customers to make online (as well as mail order and in store) purchases, by using existing prepaid cards such as telephone calling cards.

Prepaid calling cards are exemplary for utilization in the present invention because they have established distribution networks and consumer acceptance. Prepaid calling cards are based on an existing, ubiquitous commodity (phone minutes), which do not require the consumer to accept a new technology such as digital wallets. Prepaid calling cards are available in conveniently small denominations and can sometimes be recharged. This makes calling cards an ideal method to provide a fixed, prepaid amount of money as a gift or a budgeting method. Unlike credit cards or other stored value payment systems, phone cards are disposable, global, are available to everyone with the means to purchase one, and don't require age restrictions.

The present invention allows exchanging the value stored in or referenced by a phone card for online goods and services. The DPCS links online merchants with the prepaid calling card billing system. A consumer purchases a phone card through the same channels they can today—a local newsstand or convenience store. The same identification system on the card used for a telephone call is now used by the DPCS to allow additional purchasing opportunities.

Online merchants can now provide services to a whole new class of consumer—those without credit cards, people on a fixed budget (e.g. students) and those wishing additional anonymity.

Moreover, the DPCS can be extended to allow purchases secured by any billing system. An example of this is when network convergence becomes a reality to the consumer's home, the use of prepaid cable, streaming media, and many other premium content technologies can and will be enabled by the present invention.

The DPCS payment system works with existing browsers and e-commerce systems. It requires no browser plug-ins or any software download by the end user. It's also convenient for the merchant—a few additional fields on the payment portion of checkout and some plug in modules to their e-commerce system.

The DPCS is thus an online transaction processing technology that links online merchants to payment authorization systems used by prepaid calling card vendors. The DPCS system is built upon industry standards for Electronic Data Interchange (EDI) and existing and evolving Internet standards. By leveraging standard technology, the DPCS system can be easily integrated into other systems and extended to provide new functions.

The DPCS payment system has several important advantages that distinguish it from other Internet payment systems. In today's marketplace, many wallet-like technologies are fighting to have online merchants to adopt their technology. Only then do they ask the consumers to adopt the technology. This puts the burden on the merchant to promote the payment method. A key component of the DPCS strategy is that it brings the consumers who have already embraced a payment technology to the merchant.

Unlike a credit card transaction, the DPCS system is completely anonymous. Just like cash, there is no way to trace a transaction once it has taken place, and no statement is sent to the customer. The cards can be purchased in stores just like a prepaid phone card, or any other item. Consumers do not have to set up an account or provide a credit card or identification. They simply buy a card, use up the balance stored on it, and discard it when they are finished.

Thus, the present invention is a system and method for executing payment for transaction of goods or services between a merchant and a consumer, by the merchant first requesting the consumer to provide to it a consumer account identifier that identifies a prepaid consumer account for use with a specific service. The consumer provides the requested account identifier to the merchant, and the merchant using a merchant computer sends to a digital petty cash server (DPCS) a first transaction request message including the consumer account identifier provided by the consumer and a merchant transaction amount for which authorization is being requested. The DPCS sends to an account server a second transaction authorization request message including the consumer account identifier provided by the consumer and a DPCS transaction amount for which authorization is being requested. The account server determines if the consumer account is sufficient to cover the DPCS transaction amount, and if so, it deducts from the consumer account the DPCS transaction amount and completes the transaction between the merchant and the consumer. If the consumer account is insufficient to cover the DPCS transaction amount, then the transaction between the merchant and the consumer is denied.

In order to complete the transaction after authorization, the account server sends a first transaction authorization message to the DPCS, the DPCS logs the authorization in a transaction database and sends a second transaction authorization message to the merchant computer. The merchant then indicates to the consumer that the transaction has been authorized.

The account server will deny the transaction by sending a first transaction denied message to the DPCS, which then logs the first transaction denied message in a transaction database and sends a second transaction denied message to the merchant computer. The merchant will then indicate to the consumer that the transaction has been denied.

The DPCS is capable of communicating with a plurality of different account servers, wherein each account server is configured to store information on consumer accounts to be used with a different consumer service. The DPCS determines which of the plurality of account servers should be sent the second transaction authorization request message request by analyzing the consumer account identifier.

By way of example, the account server may be configured to provide prepaid telephone card calling services in which the prepaid consumer account is used to pay for telephone calls made by the consumer. In this case, the consumer prepays for said account by purchasing a telephone calling card, the telephone calling card having imprinted thereon the consumer account identifier such as a telephone number of the telephone card calling service.

The consumer may utilize a consumer computer that communicates with the merchant computer over the Internet, in which case the merchant computer is used by the merchant to request the consumer to provide the consumer account identifier by sending an account entry form to the consumer computer, and to indicate to the consumer that the transaction has been authorized or denied by sending a web page to the consumer computer. In the alternative, the merchant and the consumer may each utilize a telephone to communicate with each other over a telephone network in order for the merchant to request the consumer to provide the consumer account identifier and indicate to the consumer that the transaction has been authorized or denied.

### BRIEF DESCRIPTION OF THE DRAWING

FIG. 1 is a block diagram of the system of the present invention;

FIG. 1A is an illustration of a prior art calling card that may be used with the system of FIG. 1;

FIG. 2 is an illustration of a payment web page used in the system of FIG. 1;

FIG. 3 is an illustration of a pop-up window sent by the merchant computer to request card data from a consumer using the system of FIG. 1; and

FIG. 4 is a flowchart of the operation of the system of FIG. 1.

### DETAILED DESCRIPTION OF THE PREFERRED EMBODIMENT

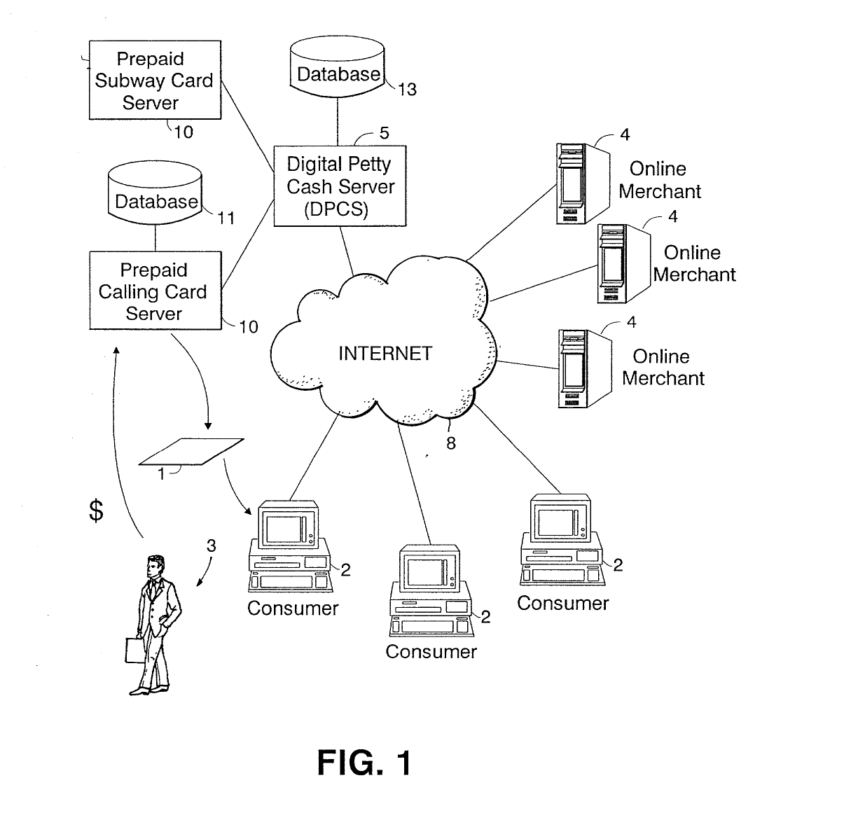

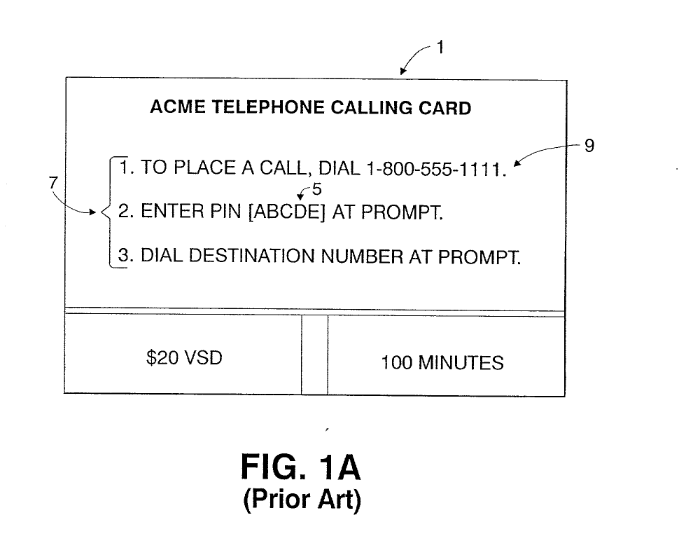

Referring to FIG. 1, the system of the present invention is shown in top level format. As well known in the prior art (and shown in FIG. 1A), a prepaid vending card such as a telephone card 1 typically has printed thereon the information necessary to effect long distance telephone calls. In particular, a typical prepaid telephone card includes an access telephone number 3, for example an 800 number, used to access the prepaid calling system. The card also includes a unique authentication code or ID code 5 which is used to access a particular account, which account is usually stored in a database 11 resident at a prepaid calling card server 10. Finally, the card 1 includes instructions 7 for placing long distance calls, whether domestic or international. Such prepaid cards 1 are typically sold in predetermined denominations, for example $5, $10, $20, $50, and the like. Moreover, such cards 1 are often sold at convenience stores and other retail outlets.

The prepaid card 1 has printed thereon a telephone number by which a consumer may access the service network operated by the service provider. Upon dialing the access telephone number 3 (e.g., an 800 telephone number), the consumer enters the ID code 5 printed on the prepaid card, for example in response to a voice or other prompt from the service provider host computer. Upon receipt of the ID number, the service provider host computer interrogates its database 11 in server 10 to determine whether sufficient funds exist in that account to permit the consumer to make a long distance call. If not, the consumer is informed that his account is fully depleted, and invited to purchase a new prepaid card or make other arrangements for paying the long distance charges for this particular call. If, however, the prepaid account has sufficient funds available to permit a long distance call, the consumer 3 enters the telephone number of his desired destination, for example in response to a voice or other prompt from the host computer. The consumer 3 will then be connected to his destination, and will be permitted to engage in his telephone call until the available funds in his account are depleted.

A major advantage of the present invention is the ability to use such a card 1 for its intended purposes (long distance phone calls) as well as for making payments over the Internet, interchangeably. In this manner, the consumer needs to buy only one type of prepaid card, and that card is useable for these different purposes.

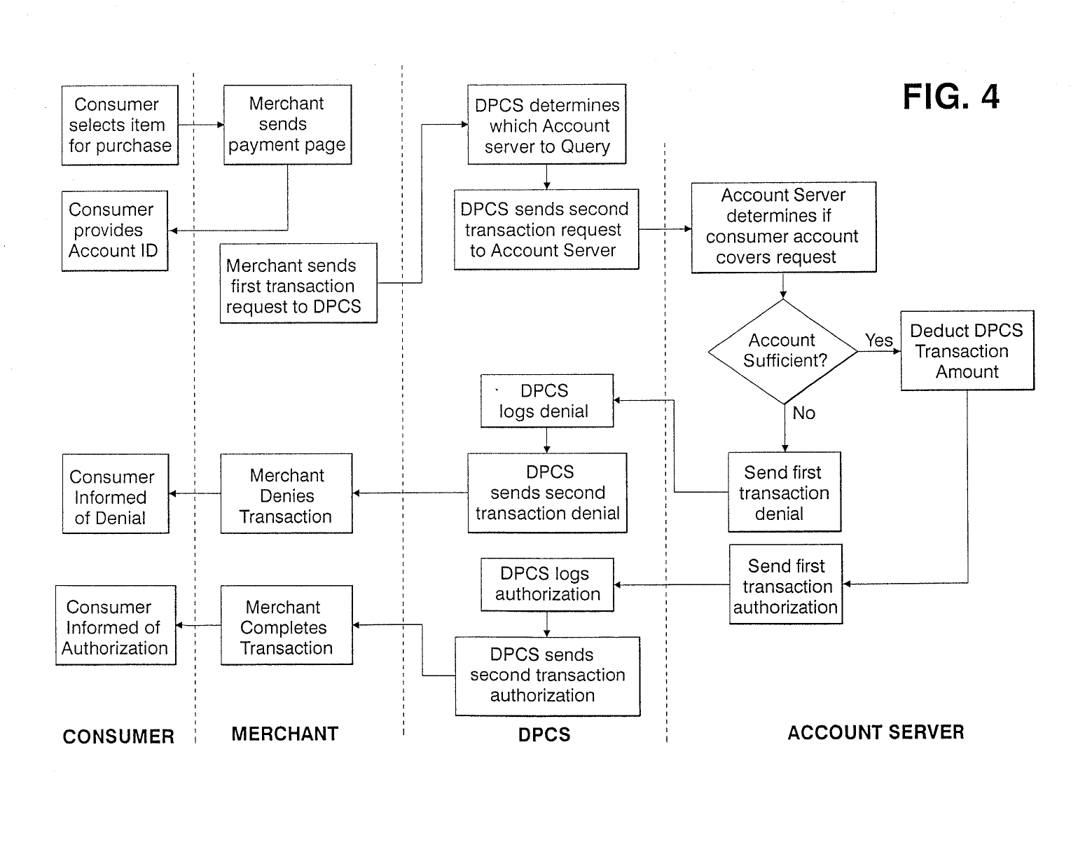

The present invention takes advantage of this existing methodology and infrastructure as follows (with reference to FIG. 4). A plurality of consumer computers 2 are interconnected by means well known in the art to the Internet 8. Likewise, a plurality of online merchant computers 4 are interconnected to the Internet 8. The consumer computers 2 and online merchant computers 4 interact with each other to provide information in the form of web pages to the consumers 3, which inform the consumers as to certain products or services that are offered for sale over the Internet 8. For example, a consumer 3 may desire to purchase an article from a merchant computer 4, which will consist of the download of a file from the online merchant computer 4 to the consumer computer 2 once payment has been established.

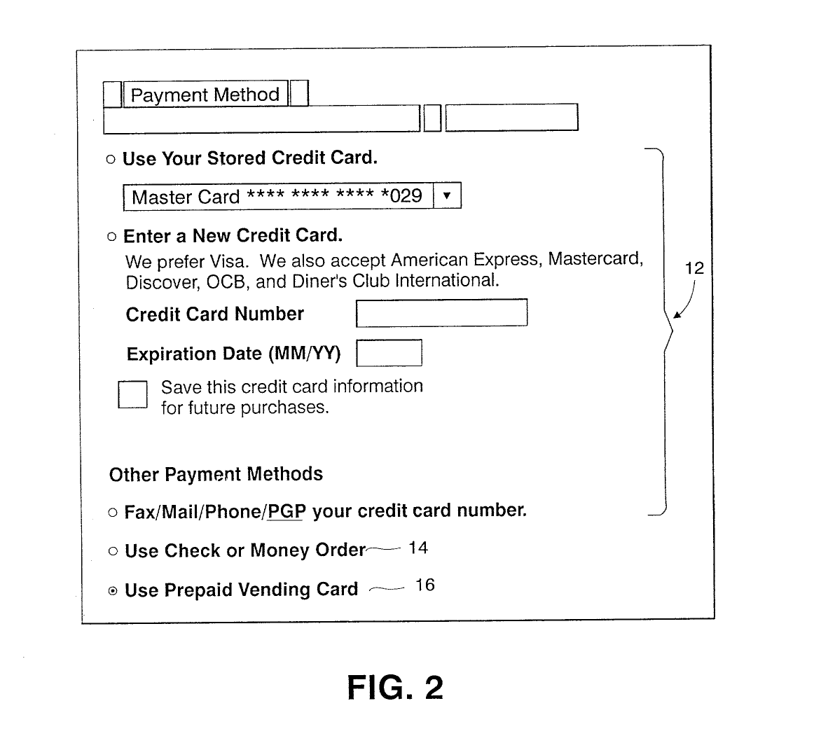

FIG. 2 shows a payment web page that is sent to the consumer computer 2 by the merchant computer 4. In addition to the prior art payment mechanism by credit card 12 or check/money order 14, the web page provides an option 16 for using a prepaid vending card 1. In the preferred embodiment, the prepaid vending card 1 is a prepaid telephone card, but it of course may be a card utilized by another type of centrally administered prepaid system (such as a prepaid subway card).

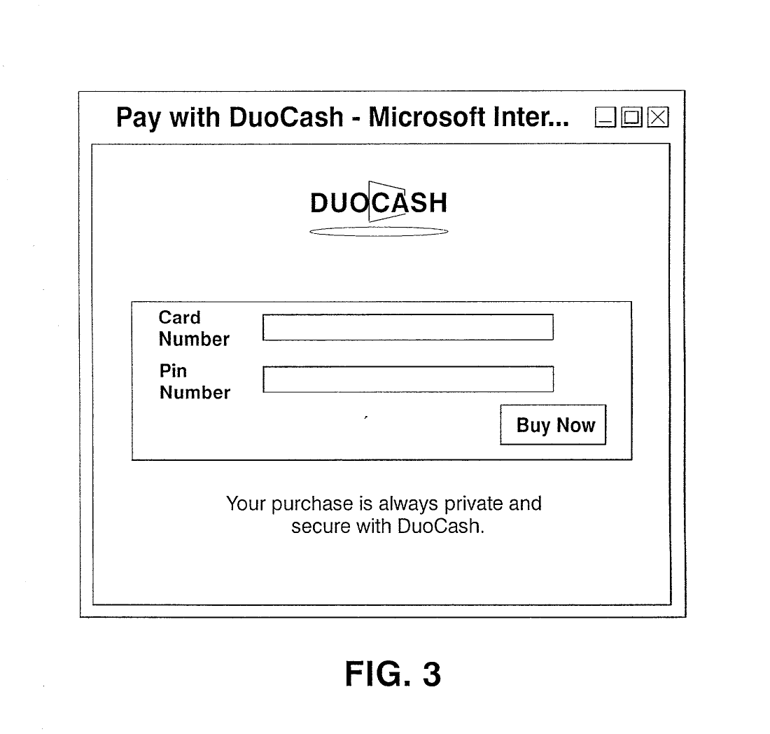

When the user clicks on the prepaid vending card option 16, a screen will appear that will prompt the consumer to enter the account identifier (in this case the card number and PIN number). In the alternative to a separate screen, the entry fields can be included on the main payment web page. FIG. 3 illustrates a pop-up window with these data entry fields. Once entered, the card number will be sent to the merchant computer 4 for further processing.

The merchant computer 4 will formulate a first transaction authorization request message that will include the consumer account identifier (e.g. card number and PIN number) and the merchant transaction amount (the amount of money the merchant wishes to collect on the transaction), but a preferably not the name or any other identification indicia of the consumer. This authorization request is sent via the Internet to the DPCS 6, which then formulates a second transaction authorization request message for transmission to the relevant prepaid card account server 10. In this case, the DPCS will query the prepaid calling card server 10 by sending the second transaction authorization request message. The second transaction authorization request message may include a request for authorization for a DPCS transaction amount, which is likely a larger amount than the merchant transaction amount requested by the merchant in the first transaction authorization request message, the added amount being the processing fee (if implemented) for the DPCS. Thus, for example, if the purchase amount for the article is 50 cents, the DPCS may request payment of 55 cents, which includes the 5 cents payment to the DPCS for processing the transaction. Of course, if the system is configured such that the DPCS does not mark up the payment request as such, then the DPCS transaction amount will be the same as the merchant transaction amount.

The DPCS 6 is configured to communicate and interact with the prepaid card account server 10 by any means of communication that is available, i.e. a dial-up connection, Internet connection, etc. The DPCS will preferably utilize the protocol expected by the account server 10 to request a deduction of the purchase amount as would a device normally interconnected to the account server 10. Thus, in our example, the card server utilizes a card database 11 having a plurality of records, each record having a card number and a corresponding account amount left on the card 1. The card server 10 will deduct the DPCS transaction amount sent by the DPCS 6 from the corresponding card account record, and then send a first transaction authorization message (i.e. a purchase authorization) back to the DPCS 6. The DPCS will then log the authorization in a transaction database, and send a second transaction authorization message to the merchant computer 4. The merchant computer 4 will then complete the transaction with the consumer computer 2.

In the event that the account server 10 determines that the consumer account is insufficient to cover the DPCS transaction amount, it will deny the transaction by sending a first transaction denied message to the DPCS. The DPCS will log the transaction denial in the transaction database, and then send a second transaction denied message to the merchant computer 4. The merchant computer 4 will then in turn indicate to the consumer computer 2 that the transaction has been denied (and possibly offer another mode of payment to the consumer).

The online merchant 4, DPCS 6, and account server 10 will reconcile the transaction payments in some periodic fashion. For example, each day, the account server 10 could tally the total amounts owed to the DPCS and credit an account accordingly. Likewise, the DPCS could do the same with respect to each online merchant that it does business with, keeping a percentage as processing fees as described previously.

Thus, as described herein, the present invention takes advantage of the existing methodology and infrastructures of an existing prepaid card system such as a calling card, to allow easy and effective payments for goods and services over the Internet. A similar method could also be used by effecting mail order or catalog purchases, wherein the consumer would simply call in the order to the vendor, and give the prepaid calling card number as an alternative means of payment as described above.

In addition, it is envisioned that the DPCS will act as a universal gateway to a number of different existing payment systems. The DPCS would determine which of the account servers should be sent the second transaction authorization request message request by analyzing the consumer account identifier received from the merchant computer. In this manner, the system would recognize many different types of cards that may be used by a consumer for payment.

Although the preferred embodiment utilizes computers to help automate communications between the merchant and the consumer, it is envisioned that he present invention could also be carried out by other means of communication. Thus, for example, a consumer could telephone the merchant, such as in the case of a catalog order, and give the account information to the merchant over the telephone. The merchant could then enter the account information into the merchant computer 4 for authorization as described above. Also, the system could use DTMF and IVR techniques well known in the art for accomplishing this input function.

As a security measure, the account identifier entered by the consumer into the screen of FIG. 3 could be obfuscated or otherwise masked so as to prevent someone from intercepting the data for illicit purposes. For example, the consumer could be instructed to enter every other digit and the full identification could be reconstructed by the merchant computer. Or, an algorithm could be employed to encrypt or obfuscate the data entered by the computer, and the reverse algorithm could be used at the receiving end to de-obfuscate or decrypt the string as required.

In addition to using prepaid accounts such as the telephone card in the preferred embodiment, it is envisioned that any pre-existing account may be utilized by the system, even if not prepaid. For example, a user's Internet Service Provider's monthly billing scheme could be used by having the customer enter an indicator of the ISP, and then an account number or password. The ISP accounting system would be contacted by the DPCS for debiting the customer's account with the transaction amount as described above. The customer would be billed by the ISP in the next billing cycle (i.e. monthly) to cover the added cost of the item purchased from the merchant.

Applications of the System

The DPCS card can be easily adapted to serve as a gift certificate. The cards used for this purpose might only allow the recipient to use the card at a particular vendor, or a set of vendors (e.g. “bookstores”). In addition, special versions of the DPCS card targeted to certain markets such as teenagers will be developed which will restrict how the card can be spent. This will give parents an added level of control over what their children spend their money on.

Because of the small amounts stored on or with reference to the cards and the resistance to fraud, the present invention is especially appropriate as a payment mechanism for those who provide content over the Internet. Content providers such as the Wall Street Journal, or various sites which sell software or mp3 music can use this system to easily and securely sell their material.

As computer hardware improves in power and speed and drops in price, and Internet connections increase in availability and speed, online multiplayer games are becoming increasingly popular. This growth will be fueled in part by the arrival of a new generation of low-priced, user-friendly video game consoles from Sony, Sega and Nintendo which support advanced 3D graphics and include built-in modems which are designed to connect to the Internet. Online gaming sessions are impulse purchases which appeal to many of those who either do not have credit cards, or who desire to preserve their anonymity while role-playing online. Since online gaming first began almost 20 years ago, the press has periodically written scare stories about gamers who lost track of time and ran up hundreds or even thousands of dollars worth of bills on their credit cards. The addictive quality of online games makes them particularly suitable for the built-in spending limits of a pre-paid card.

In addition, there is a lot of discussion in the technology/software industry about in the future of not selling shrink-wrapped software, but charging per-use pricing. Example: Currently you purchase Word 98 for $99.95 and then every few years you upgrade at reduced cost. The idea that is being brought forward is for you to point your network connection to www.xyz.com and use Word98 for a few dollars a month. This new distribution method would create tremendous opportunity for the DPCS system since business and individuals would be seeking a payment method. We believe that there currently are ASP in operations and knows that partnership opportunities exist today.

With the impending explosive growth of small to medium merchants coming to the web, one major challenge they face is they will not be able to leverage advertising as a revenue model due primarily to their size. They then will need to recover their cost by moving to a subscription service model similar to AAA and many other clubs in existence. The upfront and maintenance cost of setting today billing systems will prove not to be an option for these small to medium size business. Today this model exists and is utilized mostly by specialty clubs, Pager Weather Services, and magazines.

We claim:

1. A method for executing payment for transaction of goods or services between a merchant and a consumer comprising the steps of:
a) the merchant requesting the consumer to provide to it a consumer account identifier that identifies a prepaid consumer account for use with a specific service;
b) the consumer providing the requested account identifier to the merchant;
c) the merchant using a merchant computer to send to a digital petty cash server (DPCS) a first transaction request message comprising the consumer account identifier provided by the consumer and a merchant transaction amount for which authorization is being requested;
d) the DPCS sending to an account server a second transaction authorization request message comprising the consumer account identifier provided by the consumer and a DPCS transaction amount for which authorization is being requested;
e) the account server determining if the consumer account is sufficient to cover the DPCS transaction amount;
f) if the consumer account is sufficient to cover the DPCS transaction amount, then deducting from the consumer account the DPCS transaction amount and completing the transaction between the merchant and the consumer; and
g) if the consumer account is insufficient to cover the DPCS transaction amount, then denying the transaction between the merchant and the consumer.

2. The method of claim 1 wherein the step of completing the transaction between the merchant and the consumer comprises the steps of:
i) the account server sending a first transaction authorization message to the DPCS;
ii) the DPCS logging the authorization in a transaction database;
iii) the DPCS sending a second transaction authorization message to the merchant computer; and
iv) the merchant indicating to the consumer that the transaction has been authorized.

3. The method of claim 2 wherein the step of denying the transaction between the merchant and the consumer comprises the steps of:
i) the account server sending a first transaction denied message to the DPCS;
ii) the DPCS logging the first transaction denied message in a transaction database;
iii) the DPCS sending a second transaction denied message to the merchant computer; and
iv) the merchant indicating to the consumer that the transaction has been denied.

4. The method of claim 1 wherein the DPCS is capable of communicating with a plurality of different account servers, each account server configured to store information on consumer accounts to be used with a different consumer service, and wherein the DPCS determines which of the plurality of account servers should be sent the second transaction authorization request message request by analyzing the consumer account identifier.

5. The method of claim 1 wherein the account server is configured to provide prepaid telephone card calling services in which the prepaid consumer account is used to pay for telephone calls made by the consumer.

6. The method of claim 5 wherein the consumer prepays for said account by purchasing a telephone calling card, the telephone calling card having imprinted thereon the consumer account identifier.

7. The method of claim 6 wherein the consumer account identifier is a telephone number of the telephone card calling service.

8. The method of claim 3 wherein the consumer utilizes a consumer computer that communicates with the merchant computer over the Internet, and wherein the merchant computer is used by the merchant to request the consumer to provide the consumer account identifier by sending an account entry form to the consumer computer, and to indicate to the consumer that the transaction has been authorized or denied by sending a web page to the consumer computer.

9. The method of claim 3 wherein the merchant and the consumer each utilize a telephone to communicate with each other over a telephone network in order for the merchant to request the consumer to provide the consumer account identifier and indicate to the consumer that the transaction has been authorized or denied.

10. A networked system for executing payment for transaction of goods or services between a merchant and a consumer comprising:
a) a merchant computer;
b) a consumer computer;
c) a digital petty cash server (DPCS); and
d) an account server;
wherein the merchant computer is configured to request the consumer computer to provide to it a consumer account identifier that identifies a prepaid consumer account for use with a specific service, the prepaid consumer account stored on the account server; and to send to the transaction server a first transaction request message comprising the consumer account identifier provided by the consumer computer and a merchant transaction amount for which authorization is being requested;
wherein the DPCS is configured to send to the account server a second transaction authorization request message comprising the consumer account identifier provided by the consumer computer and a DPCS transaction amount for which authorization is being requested;
wherein the account server is configured to determine if the consumer account is sufficient to cover the DPCS transaction amount; and to deduct from the consumer account the DPCS transaction amount and allow the transaction if the consumer account is sufficient to cover the DPCS transaction amount; and to deny the transaction between the merchant computer and the consumer computer if the consumer account is insufficient to cover the DPCS transaction amount.

11. The system of claim 10 wherein the account server is configured to allow the transaction by sending a first transaction authorization message to the DPCS; and wherein the DPCS is configured to log the authorization in a transaction database and to send a second transaction authorization message to the merchant computer; and wherein the merchant computer is configured to indicate to the consumer that the transaction has been authorized.

12. The system of claim 11 wherein the account server is configured to deny the transaction by sending a first transaction denied message to the DPCS; and wherein the DPCS is configured to log the first transaction denied message in a transaction database and to send a second transaction denied message to the merchant computer; and wherein the merchant computer is configured to indicate to the consumer that the transaction has been denied.

13. The system of claim 10 further comprising a plurality of different account servers, each account server configured to store information on consumer accounts to be used with a different consumer service; wherein the DPCS is configured to communicate with any of the plurality of different account servers and to determine which of the plurality of account servers should be sent the second transaction authorization request message request by analyzing the consumer account identifier.

14. The system of claim 10 wherein the account server is configured to provide prepaid telephone card calling services in which the prepaid consumer account is used to pay for telephone calls made by the consumer.

15. The system of claim 14 wherein the consumer prepays for said account by purchasing a telephone calling card, the telephone calling card having imprinted thereon the consumer account identifier.

16. The system of claim 15 wherein the consumer account identifier is a telephone number of the telephone card calling service.
